(19) United States
(12) Patent Application Publication
(10) Pub. No.: US 2026/0028860 A1
(43) Pub. Date: Jan. 29, 2026

(54) MOTOR VEHICLE LOCK

(71) Applicant: Brose Schliesssysteme GmbH & Co. Kommanditgesellschaft, Wuppertal (DE)

(72) Inventors: Markus Zillert, Duesseldorf (DE); Ludger Graute, Essen (DE)

(21) Appl. No.: 18/996,692

(22) PCT Filed: Jul. 19, 2023
(86) PCT No.: PCT/EP2023/070005

§ 371 Date: Jan. 17, 2025

(30) Foreign Application Priority Data
Jul. 20, 2022 (DE) 10 2022 118 115.4

(51) Int. Cl. E05B 81/14; E05B 81/06; E05B 81/30; E05B 81/34; E05B 81/90

(52) U.S. Cl. CPC E05B 81/14; E05B 81/06; E05B 81/30; E05B 81/34; E05B 81/90

(57) ABSTRACT

A motor vehicle lock with a locking latch and at least one locking pawl, wherein the locking latch is adjustable into an open position and into at least one closed position, wherein the motor vehicle lock has an operating lever, wherein a coupling arrangement is arranged between the operating lever and the locking pawl, said coupling arrangement being switchable between an engaged state and a disengaged state, wherein the motor vehicle lock has an opening device with a motorized opening drive with at least one drive direction which in an opening movement adjusts an actuating arrangement of the opening device, starting from an initial position of the actuating arrangement, such that the actuating arrangement operates an opening lever of the opening device which is pivotable about an opening lever axis, such that the locking pawl can be transferred by an operating stroke of the opening lever into a raised position.

### CROSS-REFERENCE TO RELATED APPLICATIONS

This application is a national stage application under 35 U.S.C. 371 of International Patent Application Serial No. PCT/EP2023/070005, entitled “Motor Vehicle Lock,” filed Jul. 19, 2023, which claims priority from German Application No. DE 10 2022 118 115.4, filed Jul. 20, 2022, the disclosure of which is incorporated herein by reference.

### FIELD OF THE TECHNOLOGY

Various embodiments relate to a motor vehicle lock.

### SUMMARY

The known motor vehicle lock (DE 10 2013 110 201 A1), on which some embodiments are based, is provided with a locking latch which is pivotable about a geometric locking latch axis and with at least one locking pawl which is pivotable about a geometric locking pawl axis, wherein the locking latch is adjustable into an open position and into at least one closed position and wherein the locking pawl in a lowered position holds the locking latch in the closed position and in a raised position releases the locking latch. The motor vehicle lock has an electric opening device with an opening drive which in an opening movement adjusts an actuating arrangement of the opening device, starting from an initial position of the actuating arrangement, such that the actuating arrangement raises the locking pawl with the opening movement.

Moreover, the motor vehicle lock has an operating lever which is pivotable about a geometric operating lever axis, wherein a coupling arrangement is arranged between the operating lever and the locking pawl, said coupling arrangement being switchable between an engaged state and a disengaged state. While in the disengaged state the operating stroke of the operating lever is an idling stroke relative to the raising of the locking pawl, in the engaged state the locking pawl can be raised via the operating stroke of the operating lever.

Thus the motor vehicle lock can be implemented as an “electric lock with mechanical redundancy” which in principle in the context of an opening function can be opened in a motorized manner by means of the opening device. In the event of an emergency, at least one additional drive train is provided, such as for an external door handle, which can be interconnected by means of the coupling arrangement to the locking pawl to be raised.

The known motor vehicle lock ensures a reliable raising of the locking pawl. If a blocking, canting or catching of a component of the opening device occurs in the raised position of the locking pawl, the transfer of the locking pawl into the lowered position thereof represents a challenge.

The object of various embodiments is to design and to develop the known motor vehicle lock such that the operational safety is further improved.

The motor vehicle lock under discussion can be assigned to any closure element of a motor vehicle. In this regard, the term “closure element” is to be widely interpreted. It comprises, for example, a side door, in particular a rear side door, a rear door, a tailgate, a trunk lid, a front hood, an engine hood, or the like. The closure element can be articulated to the body of the motor vehicle in the manner of a pivoting door or in the manner of a sliding door.

Essentially, the main consideration is to arrange the coupling arrangement both between the operating lever and the locking pawl and between the opening device and the locking pawl such that both the operating lever and the opening device can be uncoupled from the locking pawl. In such a case, it is ensured that the locking pawl is transferred back into the lowered position thereof and the closure element can be closed and locked, whereby the operational safety of the motor vehicle lock can be increased.

In detail, it is proposed that the coupling arrangement is arranged between the opening lever and the locking pawl such that for transferring the locking pawl into the raised position thereof the opening device is coupled or can be coupled via the coupling arrangement thereto, and that the opening device can be uncoupled from the locking pawl via the coupling arrangement.

Various embodiments relate to a coupling arrangement in which in the disengaged state the operating stroke of the opening lever brings about the raising of the locking pawl and in which in the engaged state the locking pawl cannot be raised by an operating stroke of the opening lever.

Various embodiments relate to a coupling arrangement in which in the disengaged state and in the engaged state the operating stroke of the opening lever brings about the raising of the locking pawl. Thus the locking pawl can be raised in a motorized manner in both coupling positions, whereby a particularly high level of operating comfort is achieved.

According to various embodiments, the coupling arrangement can be brought into a further third state, the uncoupled state, in which the operating stroke of the opening lever is an idling stroke. In this manner, the opening device can be uncoupled in a particularly reliable manner from the locking pawl.

Various embodiments relate to structural embodiments of the coupling arrangement, whereby a simple and reliable construction of the coupling arrangement is implemented.

According to various embodiments, the motor vehicle lock has a release lever which is coupled or can be coupled to the locking pawl and via which the raising of the locking pawl can be brought about. The coupling lever is arranged on the release lever, whereby a particularly simple and compact construction of the coupling arrangement can be implemented.

In various embodiments, the motor vehicle lock also has a locking arrangement, whereby the switching of the coupling arrangement is achieved by a particularly simple and reliable construction.

In various embodiments, the motor vehicle lock has an emergency locking device for transferring the coupling arrangement into the uncoupled state thereof. It is possible to permit a locking of the motor vehicle lock in a particularly simple and reliable manner when the opening device blocks the locking pawl in the raised position thereof.

According to various embodiments, the raising of the locking pawl in a motorized manner by means of the opening device leads to a transfer of the locking arrangement into the locked state thereof. In this manner it is ensured that, in normal operation as intended, the motor vehicle lock is always locked and the lock element is opened from outside only in a motorized manner, whereby a high level of operating comfort is achieved.

The coupling arrangement according to various embodiments is able to be transferred, starting from the initial position, into the engaged state thereof by the actuating arrangement, in an unlocking movement opposing the opening movement. On the one hand, the locking pawl can be raised via the opening movement. However, on the other hand, with the unlocking movement there is a separate drive movement which permits an unlocking, in particular without a risk of the locking pawl being inadvertently raised and thus the locking latch being inadvertently opened, so that as a result the locking pawl can be raised manually via the operating lever. The proposed motor vehicle lock also advantageously requires a single drive, which is used both as an unlocking drive and as an opening drive.

Various embodiments provide a motor vehicle lock with a locking latch which is pivotable about a geometric locking latch axis and with at least one locking pawl which is pivotable about a geometric locking pawl axis, wherein the locking latch is adjustable into an open position and into at least one closed position, in particular into a main closed position and optionally into a preclosed position located between the open position and main closed position, wherein the locking pawl is adjustable into a lowered position in which the locking pawl holds the locking latch in the at least one closed position, and into a raised position in which the locking pawl releases the locking latch, wherein the motor vehicle lock has an operating lever, in particular an external operating lever, which is pivotable about a geometric operating lever axis, wherein a coupling arrangement is arranged between the operating lever and the locking pawl, said coupling arrangement being switchable between an engaged state and a disengaged state, wherein in the disengaged state the operating stroke of the operating lever is an idling stroke relative to the raising of the locking pawl, wherein in the engaged state the locking pawl can be transferred via the operating stroke of the operating lever into the released state, wherein the motor vehicle lock has an opening device with a motorized opening drive with at least one drive direction which in an opening movement adjusts an actuating arrangement of the opening device, starting from an initial position of the actuating arrangement, such that the actuating arrangement operates an opening lever of the opening device which is pivotable about an opening lever axis, such that the locking pawl can be transferred by an operating stroke of the opening lever from the lowered position into the raised position, wherein the coupling arrangement is arranged between the opening lever and the locking pawl such that for transferring the locking pawl into the raised position thereof, the opening device is coupled or can be coupled thereto via the coupling arrangement and that the opening device can be uncoupled from the locking pawl via the coupling arrangement.

In various embodiments, in the disengaged state of the coupling arrangement the operating stroke of the opening lever brings about the transfer of the locking pawl into the released state thereof, and in the engaged state of the coupling arrangement the operating stroke of the opening lever is an idling stroke relative to the raising of the locking pawl.

In various embodiments, in the engaged state and in the disengaged state of the coupling arrangement the operating stroke of the opening lever in each case brings about the transfer of the locking pawl into the released state thereof.

In various embodiments, the coupling arrangement is switchable into an uncoupled state in which the operating stroke of the opening lever is an idling stroke. In some embodiments, the operating stroke of the operating lever is an idling stroke in the uncoupled state of the coupling arrangement.

In various embodiments, the coupling arrangement has a coupling lever which is pivotable about a geometric coupling lever axis, the coupling lever in the disengaged state of the coupling arrangement is in a disengaged position in which the coupling lever, with an operating stroke of the operating lever, is out of coupled engagement with the operating lever, and the coupling lever in the engaged state of the coupling arrangement is in an engaged position in which the coupling lever, with an operating stroke of the operating lever, is in coupled engagement with the operating lever or comes into coupled engagement with the operating lever, and the coupling lever in the engaged position and the disengaged position, with an operating stroke of the opening lever, is in coupled engagement with the opening lever or comes into coupled engagement with the opening lever.

In various embodiments, in the uncoupled state of the coupling arrangement the coupling lever is in an uncoupled position in which the coupling lever, with an operating stroke of the operating lever, is out of coupled engagement with the operating lever and in which the coupling lever, with an operating stroke of the opening lever, is out of coupled engagement with the opening lever.

In various embodiments, the locking pawl is coupled or can be coupled to a release lever which is pivotable about a release lever axis, an operation of the release lever brings about the transfer of the locking pawl into the released state thereof, and the coupling lever is arranged on the release lever so as to be pivotable about a coupling lever axis. In some embodiments, the coupling lever is pretensioned into the uncoupled position thereof, in particular spring-pretensioned.

In various embodiments, the motor vehicle lock has a locking arrangement which can be brought into a locked state and an unlocked state, an adjustment of the locking arrangement from the locked state thereof into the unlocked state thereof brings about an adjustment of the coupling arrangement from the disengaged state thereof into the engaged state thereof, and an adjustment of the locking arrangement from the unlocked state thereof into the locked state thereof brings about an adjustment of the coupling arrangement from the engaged state thereof into the disengaged state thereof. In various embodiments, the locking arrangement can be brought into an uncoupled state, whereby the coupling arrangement is switched into the uncoupled state thereof.

In various embodiments, the locking arrangement has an actuating lever which is pivotable about a geometric actuating lever axis and a switching lever which is pivotable about a geometric switching lever axis, the pivotable actuating lever can be brought from a first actuating position into a second actuating position, the pivotable switching lever can be brought from a first switching position in which the switching lever holds the coupling lever in the disengaged position thereof, into a second switching position in which the switching lever holds the coupling lever in the engaged position thereof or the coupling lever is in the engaged position thereof, the actuating lever and the switching lever are coupled together such that an adjustment of the actuating lever from the second actuating position into the first actuating position brings about a transfer of the switching lever from the second switching position into the first switching position thereof, and an adjustment of the actuating lever from the first actuating position into the second actuating position brings about a transfer of the switching lever from the first actuating position into the second switching position thereof.

In various embodiments, the actuating lever is held by means of a latching arrangement in the first actuating position thereof and in the second actuating position thereof and the latching arrangement has a latching point which can be latched and which has to be overcome when transferred from the one actuating position to the other actuating position.

In various embodiments, the switching lever is pivotable relative to the actuating lever such that, starting from the first switching position, the switching lever can be brought into a third switching position in which the switching lever holds the coupling lever in the uncoupled position thereof without changing the position of the actuating lever.

In various embodiments, the motor vehicle lock has an emergency locking device for transferring the coupling arrangement into the uncoupled state thereof. In various embodiments, the switching lever is coupled or can be coupled to an emergency locking lever which is pivotable about an emergency locking lever axis, and in particular a manual operation of the emergency locking lever brings about a transfer of the switching lever into the third switching position thereof.

In various embodiments, the opening device is coupled to the locking arrangement such that a raising of the locking pawl in the course of an opening process brings about a transfer of the locking arrangement into the locked state thereof.

In various embodiments, the opening drive adjusts the actuating arrangement, starting from the initial position, in an unlocking movement which runs in the drive direction opposing the opening movement, such that the coupling arrangement is transferred via the actuating arrangement from the disengaged state into the engaged state. In various embodiments, in the event of a crash the opening device switches the coupling arrangement into the engaged state by means of the actuating arrangement.

### BRIEF DESCRIPTION OF THE DRAWINGS

Various aspects are explained hereinafter in more detail by way of a drawing merely representing exemplary embodiments. In the drawing

FIG. 1 shows a closure element of a motor vehicle in the form of a front side door with a proposed motor vehicle lock with a detailed view of the components of the motor vehicle lock bottom left and two detailed views of the locking mechanism consisting of the locking latch and the locking pawl bottom right,

FIG. 2 shows the essential components of the motor vehicle lock according to FIG. 1 in two perspective views,

FIG. 3 shows some of the components of the motor vehicle lock of FIG. 2 in a view from the front with the coupling arrangement in a) the disengaged state and b) the engaged state,

FIG. 4 shows the components of the motor vehicle lock of FIG. 3 in a view from the rear with the coupling arrangement in a) the disengaged state and b) the engaged state,

FIG. 5 shows the components of the motor vehicle lock of FIG. 3 in a view from the front in the opening movement a) when raising the locking pawl and b) in the case of an emergency locking and

FIG. 6 shows the components of the motor vehicle lock of FIG. 5 in a view from the rear in the opening movement a) when raising the locking pawl and b) in the case of an emergency locking.

### DETAILED DESCRIPTION

The proposed motor vehicle lock 1 shown in the drawing can be assigned to any closure element 2 of a motor vehicle. Regarding the further understanding of the term “closure element”, reference should be made to the introductory part of the description. In the exemplary embodiment shown, the closure element 2 is a side door, in this case a front side door, of the motor vehicle. All of the relevant embodiments accordingly apply to all other types of closure elements.

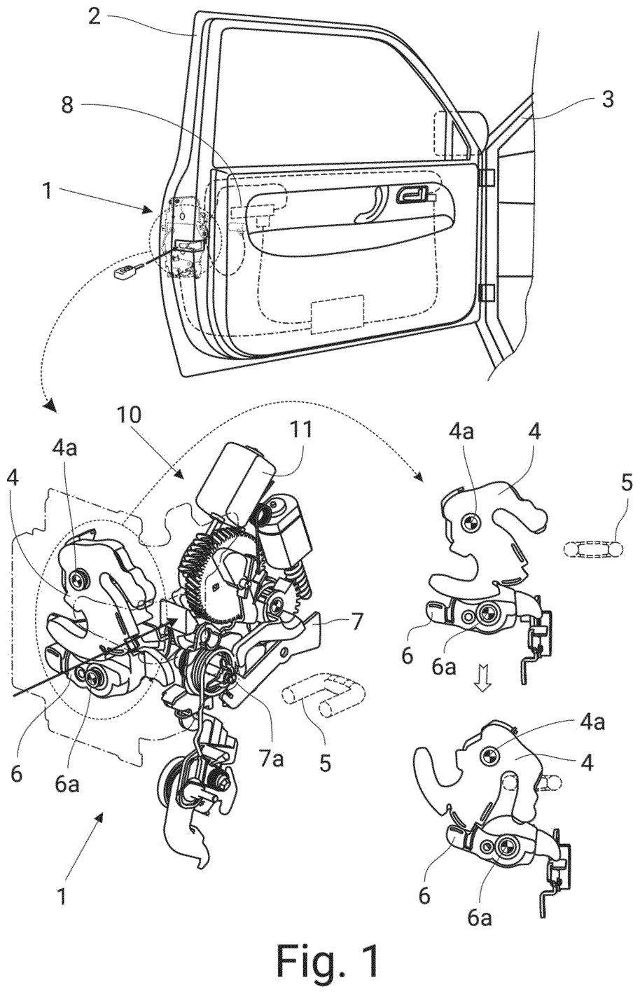

For generating a holding action between the closure element 2 and the motor vehicle body 3 of the motor vehicle, the motor vehicle lock 1 is provided with a locking latch 4, which is adjustable about a geometric locking latch axis 4a into an open position (FIG. 1, upper right drawing) into at least one closed position, in particular into a main closed position shown in the lower right drawing in FIG. 1, and into a preclosed position located between the open position and the main closed position. The locking latch 4 cooperates in the usual manner with a closing part 5, in various embodiments in the form of a locking bar, in order to hold the closure element 2 in the respective closed position thereof. The locking latch 4 is arranged on the closure element 2 while the closing part 5 is arranged on the motor vehicle body 3. This can also be provided the other way around. The locking latch 4 in various embodiments is pretensioned into the open position thereof, in particular spring-pretensioned.

For implementing the above holding action, the motor vehicle lock 1 has at least one locking pawl 6, in this case exactly one locking pawl 6. However, the proposed solution can also be applied to a multi-locking pawl system. For the purpose of a clear description, however, the following embodiments relate to an arrangement having only a single locking pawl 6.

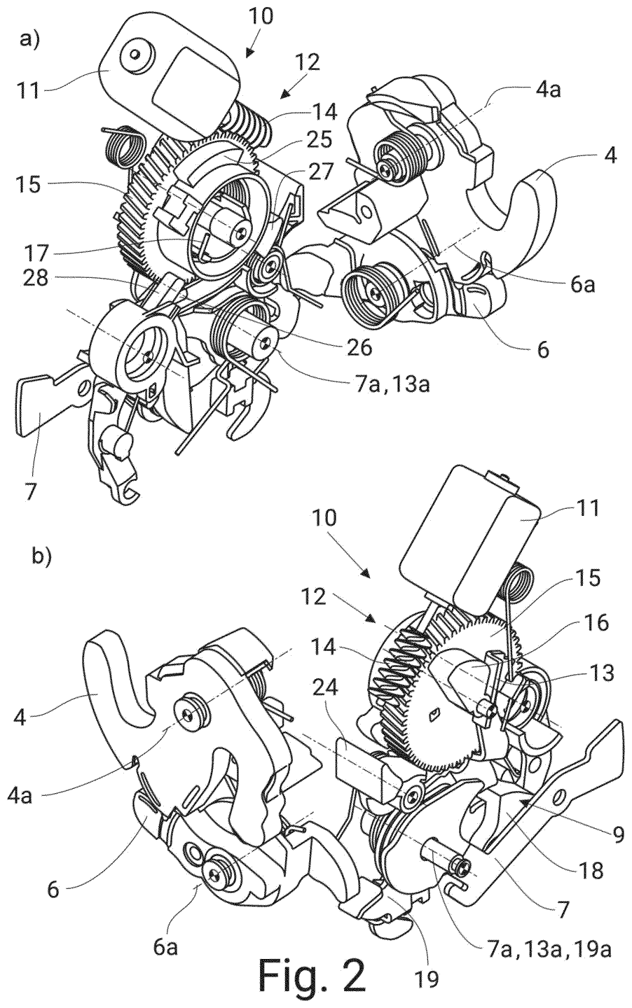

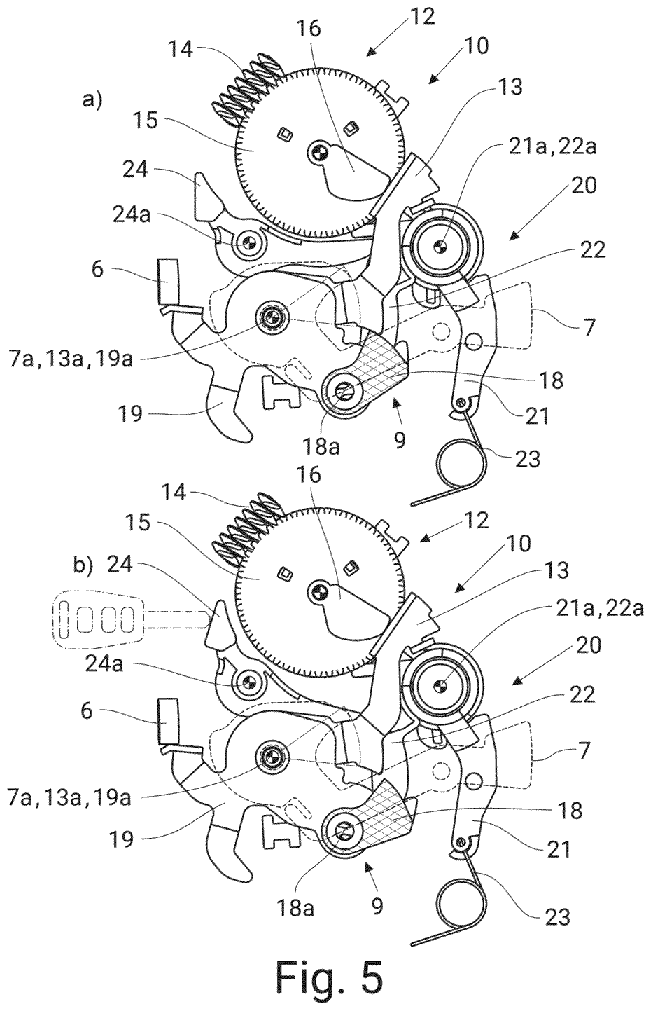

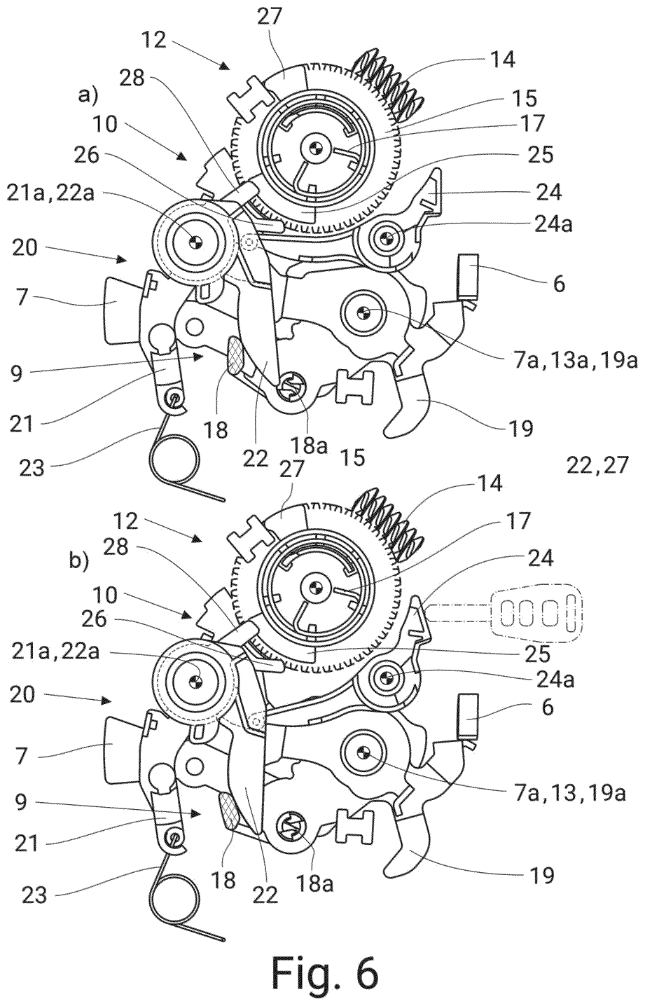

The locking pawl 6, which in this case is pivotable about a geometric locking pawl axis 6a, is adjustable from a lowered position (FIG. 1 and FIG. 2) in which it locks the locking latch 4 in the at least one closed position in the opening direction, into a raised position (FIG. 5a) and FIG. 6a)) in which it releases the locking latch 4 in the opening direction. In various embodiments, the locking pawl 6 is pretensioned into the lowered position thereof, in particular spring-pretensioned.

For raising the locking pawl 6, the motor vehicle lock 1 has an operating lever 7 which is pivotable about a geometric operating lever axis 7a and which is adjustable in an operating stroke from an initial position into an operating position. An operating stroke comprises at least one forward movement from the initial position into the respective operating position of the operating lever 7.

This operating lever 7 is in various embodiments an external operating lever, i.e. a lever which in the mounted state is coupled to an external door handle 8 of the side door. This operating lever 7 is not necessarily the only one of the motor vehicle lock 1. It is also possible that the motor vehicle lock 1 additionally has an internal operating lever.

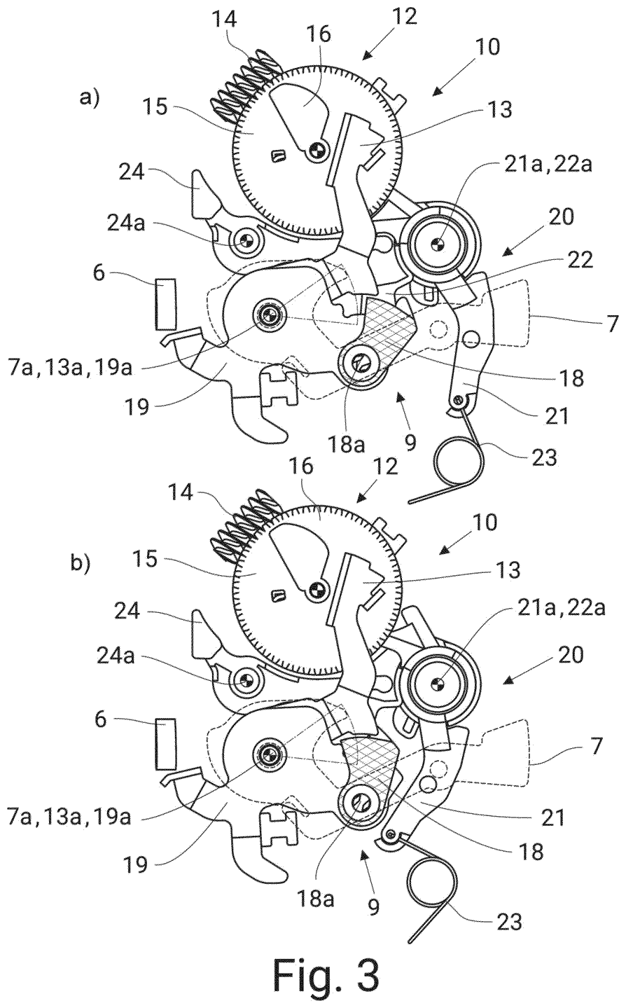

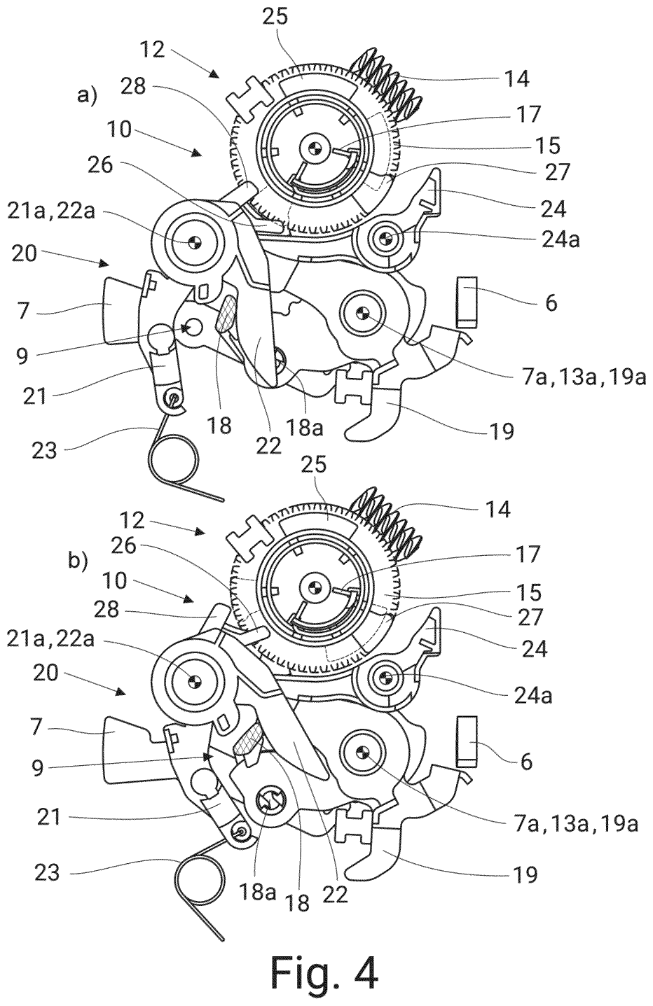

In addition, a coupling arrangement 9 which is switchable between an engaged state (FIG. 3b, FIG. 4b) and a disengaged state (FIG. 3a), FIG. 4a), FIG. 5a), FIG. 6a)) is arranged between the operating lever 7 and the locking pawl 6. In the disengaged state, the operating stroke of the operating lever 7 is an idling stroke relative to the raising of the locking pawl 6. In the disengaged state, the locking pawl 6 is thus not raised by the operating stroke of the operating lever 7. In the engaged state, however, the locking pawl 6 can be raised by the operating stroke of the operating lever 7, wherein the operating stroke is converted into a movement of the locking pawl 6 for raising the locking pawl 6. The motor vehicle lock 1 is locked as a result of switching from the engaged state into the disengaged state, so that an opening of the side door is not possible via the operating lever 7. Conversely, the motor vehicle lock 1 is unlocked by switching from the disengaged state into the engaged state.

The operating lever 7 can be designed for manual operation. In this case, the term “manual operation” is an operation which forwards a user movement via a mechanical connection to the relevant component and triggers a mechanical actuating movement there. In various embodiments, in the mounted state a user movement of the external door handle 8 with the coupling arrangement 9 in the engaged state can be mechanically transferred to the locking pawl 6 for raising the locking pawl 6, in order to implement a mechanical redundancy. In emergency operation, in particular in the event of an accident of the motor vehicle, a mechanical force transmission chain to the locking pawl 6 can also be provided.

In normal operation the locking pawl 6 is always raised in a motorized manner. For the motorized raising of the locking pawl 6, the motor vehicle lock 1 has an opening device 10 with a motorized opening drive 11 with at least one drive direction, in various embodiments with two opposing drive directions. In an opening movement, the opening device 10 adjusts an actuating arrangement 12 of the opening device 10, starting from an initial position of the actuating arrangement 12, such that the actuating arrangement 12 operates an opening lever 13 of the opening device 10 which is pivotable about an opening lever axis 13a, such that the locking pawl 6 can be transferred from the lowered position shown in FIG. 3a) into the raised position shown in FIG. 5a). The opening lever 13 is adjustable in an operating stroke from an initial position (FIG. 3) into an operating position (FIG. 5) via the opening drive 11 acting on the actuating arrangement 12, wherein the operating stroke can be transferred into a movement of the locking pawl 6 for raising the locking pawl 6.

In the exemplary embodiment shown, as well as other embodiments, the opening drive 11 can be coupled via a worm 14 to the actuating arrangement 12.

In various embodiments and shown in the figures, the actuating arrangement 12 has a worm gear 15 which meshes with the worm 14 and which can operate the opening lever 13 via a control cam 16. The opening drive 11 is advantageously configured to be restorable.

In various embodiments, the opening device 10 is provided with a single opening drive 11 which permits a simple and compact construction of the motor vehicle lock 1. In the present case, the drive directions are understood to mean the two rotational directions of the opening drive 11, which in various embodiments can be designed as a rotating electric motor.

The actuating arrangement 12 generally brings about a mechanical transfer of the opening movement thereof to the opening lever 13. In particular, the initial position of the actuating arrangement 12 is shown in FIG. 3a) and FIG. 4a), wherein the opening movement which is explained in more detail hereinafter leads to a raising of the locking pawl 6.

It is essential that the coupling arrangement 9 is arranged between the opening lever 13 and the locking pawl 6, such that for transferring the locking pawl 6 into the raised position thereof the opening device 10 is coupled or can be coupled thereto via the coupling arrangement 9, and that the opening device 10 can be disengaged from the locking pawl 6 via the coupling arrangement 9.

The phrase “arranged between the opening lever and the locking pawl” is to be understood to mean in the present case that the coupling arrangement 9 is functionally arranged between the opening lever 13 and the locking pawl 6 so that the opening lever 13 is coupled and/or can be coupled mechanically to the locking pawl 6 via the coupling arrangement 9.

For raising the locking pawl 6, the coupling arrangement 9 is configured to couple both the opening device 10 and the operating lever 7 thereto and to uncouple the locking pawl 6 both from the opening device 10 and from the operating lever 7. Thus merely a single coupling arrangement 9 is required, whereby an additional separate coupling arrangement 9 for the coupling between the opening device 10 and the locking pawl 6 can be dispensed with. The motor vehicle lock 1 thus has a particularly simple construction, whereby in addition to a small space requirement cost advantages are also provided. For example, if the opening device 10 or a component of the opening device 10 were to fall out in the raised position of the locking pawl 6, and not be able to be restored, the opening device 10 can be uncoupled from the locking pawl 6 in order to transfer the locking pawl 6 into the lowered position thereof. It is thus possible to lock the motor vehicle in spite of the malfunction of the opening device 10.

It is particularly advantageous if the actuating arrangement 12 has an actuating spring arrangement 17 which in the drive directions pretensions the actuating arrangement 12 in each case in the direction of the initial position. It can be ensured in a simple manner by the actuating spring arrangement 17 that the actuating arrangement 12 is restored without the action of the drive arrangement.

In a first embodiment, it is possible that in the disengaged state of the coupling arrangement 9 the operating stroke of the opening lever 13 brings about the transfer of the locking pawl 6 into the release state thereof and in the engaged state of the coupling arrangement 9 the operating stroke of the opening lever 13 is an idling stroke relative to the raising of the locking pawl 6. Thus in the disengaged state, a transfer of the locking pawl 6 into the raised position thereof is only possible by the opening lever 13, so that the locking pawl 6 can be raised exclusively in a motorized manner. However, in the engaged state of the coupling arrangement 9 the locking pawl 6 is able to be brought exclusively into the raised position thereof manually by the operating lever 7. If the above-mentioned malfunction of the opening device 10 were to arise with the locking pawl 6 being raised in a motorized manner, the opening device 10 can be uncoupled from the locking pawl 6 by switching the coupling arrangement 9 into the engaged state thereof. The locking pawl 6 can be transferred in this manner back to the lowered position thereof so that the motor vehicle lock 1 can be locked again.

In the second embodiment shown in the figures and in various other embodiments, it is provided that in the engaged state shown in FIG. 3b) and in the disengaged state shown in FIG. 3a) of the coupling arrangement 9 the operating stroke of the opening lever 13 in each case brings about the motorized transfer of the locking pawl 6 into the raised position thereof.

As FIG. 3a) shows, in the disengaged state of the coupling arrangement 9 the opening lever 13 is coupled or can be coupled thereby to the locking pawl 6, so that the operating stroke of the opening lever 13, which is shown in the transfer from FIG. 3a) to FIG. 5a), brings about the transfer of the locking pawl 6 into the raised position thereof. As FIG. 3a) also shows, the actuating arrangement 12 is in the initial position thereof and the locking pawl 6 is in the lowered position thereof. If the opening device 10 now adjusts the actuating arrangement 12 in an opening movement clockwise in FIG. 3a), the actuating arrangement 12 operates the opening lever 13, whereby this opening lever is pivoted clockwise in FIG. 3a) until the operating position of the opening lever 13 shown in FIG. 5a) is reached. The locking pawl 6 is transferred from the lowered position thereof (FIG. 3a)) into the raised position thereof (FIG. 5a)) by the operating stroke of the opening lever 13.

In the engaged state of the coupling arrangement 9, the operating stroke of the opening lever 13 also leads to the raising of the locking pawl 6, as visible in FIG. 3b). In various embodiments, the operating stroke of the opening lever 13 in the engaged state of the coupling arrangement 9 leads to the arrangement shown in FIG. 5a) of the lock components, as explained in more detail below.

In FIG. 5a) the motorized raising of the locking pawl 6 is shown. When the locking pawl 6 is raised, for example, if it leads to the blocking of the opening drive 11, to a blocking of the worm gear 15 of the actuating arrangement 12 or to a canting of the opening lever 13 in the position shown in FIG. 5a), the locking pawl 6 is in the raised position thereof so that a locking of the motor vehicle lock 1 is not possible. Nevertheless, in order to permit a locking, in various embodiments it can be provided that the coupling arrangement 9 can be switched into an uncoupled state in which the operating stroke of the opening lever 13 is an idling stroke. In various embodiments, the operating stroke of the operating lever 7 in the uncoupled state of the coupling arrangement 9 is also an idling stroke. T he coupling arrangement 9 is shown in the uncoupled state thereof in FIG. 5b) and FIG. 6b).

The coupling arrangement 9 can be designed in a particularly simple manner when the coupling arrangement 9 has a coupling lever 18 which is pivotable about a geometric coupling lever axis 18a, when the coupling lever 18 in the disengaged state of the coupling arrangement 9 is in a disengaged position in which the coupling lever 18, with an operating stroke of the operating lever 7, is out of coupled engagement with the operating lever 7, and when the coupling lever 18 in the engaged state of the coupling arrangement 9 is in an engaged position in which the coupling lever 18, with an operating stroke of the operating lever 7, is in coupled engagement with the operating lever 7 or comes into coupled engagement with the operating lever 7, and when the coupling lever 18 in the engaged position and the disengaged position, with an operating stroke of the opening lever 13, is in coupled engagement with the opening lever 13 or comes into coupled engagement with the opening lever 13.

In FIG. 3b) the coupling lever 18 is shown in the engaged position thereof and in FIG. 3a) in the disengaged position thereof. As can also be seen in both figures, with an operating stroke of the opening lever 13 the coupling lever 18 comes into engagement therewith, whereby the movement of the opening lever 13 is transferred to the locking pawl 6 for the raising thereof, as is made clear by the transfer from FIG. 3a) or FIG. 3b) to FIG. 5a).

FIG. 3a) also shows that in the disengaged position of the coupling lever 18, with an operating stroke, the operating lever 7 is moved past the coupling lever 18, so that the operating stroke is an idling stroke, as indicated by the dashed lines. In contrast thereto, in the engaged position (FIG. 3b) of the coupling lever 18 the operating lever 7 comes into engagement with the coupling lever 18, whereby the further movement of the operating lever 7 is transferred to the locking pawl 6 for the raising thereof.

In various embodiments and as shown in the figures, it is also provided that in the uncoupled state of the coupling arrangement 9 the coupling lever 18 is in an uncoupled position in which the coupling lever 18, with an operating stroke of the operating lever 7, is out of coupled engagement with the operating lever 7 and in which the coupling lever 18, with an operating stroke of the opening lever 13, is out of coupled engagement with the opening lever 13 as shown in FIG. 5b) and FIG. 6b).

The uncoupled position of the coupling lever 18 is shown in FIG. 5b) and FIG. 6b). As FIG. 5b) shows, in the uncoupled position, with an operating stroke of the opening lever 13 and the operating lever 7, the coupling lever 18 remains in each case out of coupled engagement with the opening lever 13 and the operating lever 7. As already discussed above, with the motorized raising of the locking pawl 6 in the raised state of the locking pawl 6, if a malfunction of the opening device 10 arises, for example a catching of the opening lever 13 with the coupling lever 18, the motor vehicle lock 1 cannot be locked, as FIG. 5a) shows. Assistance can be provided by the coupling lever 18 being transferred into the uncoupled position thereof, whereby the coupling lever 18 comes out of coupled engagement with the opening lever 13, as shown in FIG. 5b) and FIG. 6b). The locking pawl 6 can then be transferred into the lowered position thereof, since this locking pawl is uncoupled from the opening lever 13, and the locking pawl 6 can be pivoted independently of the opening lever 13.

For transferring the movement of the operating stroke of the opening lever 13 and the operating stroke of the operating lever 7 to the locking pawl 6, it is provided that the locking pawl 6 is coupled or can be coupled to a release lever 19 which is pivotable about a release lever axis 19a, that an operation of the release lever 19 brings about the transfer of the locking pawl 6 into the released state thereof and that the coupling lever 18 is arranged on the release lever 19 so as to be pivotable about the coupling lever axis 18a.

The release lever 19 in various embodiments can be pivotable from a basic position (FIG. 3 and FIG. 4) in which the locking pawl 6 is in the lowered position thereof, into a released position (FIG. 5 and FIG. 6) in which the locking pawl 6 is raised.

It is particularly advantageous if the release lever 19 is pretensioned into the basic position thereof, in particular spring-pretensioned. The release lever 19 then automatically transfers to the basic position thereof as soon as no opposing force which is greater than the pretensioning force acts thereon. In particular, the release lever 19 is pivoted automatically into the basic position thereof when, with the malfunction of the opening device 10 already described above, the release lever 19 is uncoupled from the opening device 10 via an adjustment of the coupling lever 18 into the uncoupled position thereof.

In the engaged position of the coupling lever 18 (FIG. 3b)), with an operating stroke of the operating lever 7, this coupling lever comes into engagement therewith, such that a further pivoting of the operating lever 7 clockwise in FIG. 3b) brings about a pivoting of the release lever 19 clockwise in FIG. 3b). At the same time, the release lever 19 comes into engagement with the locking pawl 6 such that, in the course of an operating stroke of the operating lever 7, the locking pawl 6 is transferred into the raised position thereof. In the engaged position (FIG. 3b)) or in the disengaged position (FIG. 3a)) of the coupling lever 18, with an operating stroke of the opening lever 13, this coupling lever comes into engagement with the opening lever 13 such that the locking pawl 6 is transferred into the raised position thereof, as shown in FIG. 5a).

In various embodiments, the coupling lever 18 is pretensioned into the engaged position thereof, in particular spring-pretensioned, whereby a particularly simple adjustment of the coupling lever 18 into the initial position thereof can be implemented.

For the simple and reliable switching of the coupling arrangement 9, it is advantageously provided that the motor vehicle lock 1 has a locking arrangement 20 which can be brought into a locked state (FIG. 3a) and FIG. 4a)) and an unlocked state (FIG. 3b), FIG. 4b), FIG. 5b) and FIG. 6b)), that an adjustment of the locking arrangement 20 from the locked state thereof into the unlocked state thereof brings about an adjustment of the coupling arrangement 9 from the disengaged state thereof into the engaged state thereof, and that an adjustment of the locking arrangement 20 from the unlocked state thereof into the locked state thereof brings about an adjustment of the coupling arrangement 9 from the engaged state thereof into the disengaged state thereof. In various embodiments, the locking arrangement 20 can be brought into an uncoupled state, whereby the coupling arrangement 9 is switched into the uncoupled state thereof.

With the transfer from the locked state of the locking arrangement 20 into the unlocked state, the coupling arrangement 9 is switched from the disengaged state thereof into the engaged state thereof, as the transfer from FIG. 4a) to FIG. 4b) together with the transfer from FIG. 3a) to FIG. 3b) shows. Conversely, with the transfer of the locking arrangement 20 from the unlocked state into the locked state, the coupling arrangement 9 is switched from the engaged state thereof into the disengaged state thereof, as the transfer from FIG. 4b) to FIG. 4a) together with the transfer from FIG. 3b) to FIG. 3a) shows in detail. Thus the coupling arrangement 9 can be switched in a simple manner into the engaged state and the disengaged state by means of the locking arrangement.

The transfer from FIG. 5a) to FIG. 5b) and from FIG. 6a) to FIG. 6b) shows the adjustment of the locking arrangement 20 from the locked state into the uncoupled state. By transferring the locking arrangement 20 into the uncoupled state, the coupling arrangement 9 is transferred into the uncoupled state thereof, as FIG. 5b) and FIG. 6b) show.

In various embodiments and as shown in the figures, for switching the coupling lever 18 into the engaged position thereof and the disengaged position thereof, it is provided that the locking arrangement 20 has an actuating lever 21 which is pivotable about a geometric actuating lever axis 21a and a switching lever 22 which is pivotable about a geometric switching lever axis 22a, that the pivotable actuating lever 21 can be brought from a first actuating position into a second actuating position, that the pivotable switching lever 22 can be brought from a first switching position, in which the switching lever 22 holds the coupling lever 18 in the disengaged position thereof, into a second switching position in which the switching lever 22 holds the coupling lever 18 in the engaged position thereof or the coupling lever 18 is in the engaged position thereof, that the actuating lever 21 and the switching lever 22 are coupled together such that an adjustment of the actuating lever 21 from the second actuating position into the first actuating position brings about a transfer of the switching lever 22 from the second switching position into the first switching position thereof, and that an adjustment of the actuating lever 21 from the first actuating position into the second actuating position brings about a transfer of the switching lever 22 from the first actuating position into the second switching position thereof.

In FIG. 4b the locking arrangement 20 is shown in the unlocked state thereof. The actuating lever 21 is thus in the second actuating position thereof and the switching lever 22 is in the second switching position thereof. The coupling lever 18 in the engaged position thereof and in various embodiments can be pretensioned by a pretensioning, in particular spring-pretensioning, into the engaged position clockwise in FIG. 4b). The coupling lever 18 can be supported on the switching lever 22 or held in a different manner in the engaged position.

For adjusting the locking arrangement 20 into the locked state thereof, the actuating lever 21 is pivoted clockwise in FIG. 4b), from the second actuating position thereof (FIG. 4b)) into the first actuating position thereof (FIG. 4a)). The actuating lever 21 is coupled to the switching lever 22, such that the switching lever 22 is pivoted clockwise in FIG. 4b) from the second switching position thereof (FIG. 4b)) into the first switching position thereof (FIG. 4a). The switching lever 22 is in engagement or comes into engagement with the coupling lever 18 such that the coupling lever 18 is transferred counterclockwise in FIG. 4b) from the engaged position thereof into the disengaged position thereof. Conversely, a pivoting of the actuating lever 21 from the first actuating position thereof (FIG. 4a)) into the second actuating position thereof (FIG. 4b)) leads to a pivoting of the switching lever 22 from the first switching position thereof into the second switching position thereof and a pivoting of the coupling lever 18 associated therewith from the disengaged position thereof (FIG. 4a)) into the engaged position thereof (FIG. 4b)).

The coupling between the actuating lever 21 and the switching lever 22 can be implemented in various embodiments via a spring and/or stops between the actuating lever 21 and the switching lever 22.

In order to hold the locking arrangement 20 in a reliable manner in the unlocked state and/or locked state thereof, it can be provided that the actuating lever 21 is held by means of a latching arrangement 23 in the first actuating position thereof and in the second actuating position thereof and that the latching arrangement 23 has a latching point which can be latched and which has to be overcome when transferred from the one actuating position to the other actuating position. In this manner the locking arrangement 20 is held in a secure manner in the locked state and in the unlocked state. An adjustment of the locking arrangement 20 into the unlocked and/or locked state can take place only by overcoming the latching point to be latched.

In FIG. 6a) the raising of the locking pawl 6 by the opening device 10 is shown. If, when the locking pawl 6 is in the raised position thereof, a malfunction of the opening device 10 arises, for example a blocking of the opening drive 11, a blocking of the actuating arrangement 12 and/or jamming of the opening lever 13, for example with the coupling lever 18, the locking pawl 6 remains in the raised position thereof so that the side door cannot be closed and the motor vehicle lock 1 cannot be locked. In order to transfer the locking pawl 6 nevertheless into the lowered position thereof and to permit the locking of the motor vehicle lock 1, it can be provided in various embodiments that the switching lever 22 is pivotable relative to the actuating lever 21 such that, starting from the first switching position (FIG. 6a)), the switching lever 22 can be brought into a third switching position (FIG. 6b)) in which the switching lever 22 holds the coupling lever 18 in the uncoupled position thereof without changing the position of the actuating lever 21.

Starting from the first switching position of the switching lever 22, shown in FIG. 6a), this switching lever is adjustable clockwise in FIG. 6a) into a third switching position shown in FIG. 6b). The switching lever 22 is pivotable relative to the actuating lever 21 such that the actuating lever 21 remains unchanged in the first switching position thereof. To this end, the actuating lever 21 can bear against a stop of a motor vehicle lock housing, not shown.

As can be identified with the transfer from FIG. 6a) to FIG. 6b), a pivoting of the switching lever 22 from the first switching position thereof into the third switching position thereof brings about a pivoting of the coupling lever 18 from the disengaged position thereof into the uncoupled position thereof.

In this manner, the coupling lever 18 comes out of engagement with the opening lever 13 so that the release lever 19 can be pivoted counterclockwise in FIG. 6b), whereby the locking pawl 6 can be transferred from the raised position thereof into the lowered position thereof, whereby an emergency locking is provided.

As can be seen from viewing FIG. 4a), FIG. 4b) and FIG. 6b) together, it can be provided in various embodiments that the first switching position of the switching lever 22 is between the second and the third switching position.

In various embodiments and as shown in the figures, it is provided that the motor vehicle lock 1 has an emergency locking device for transferring the coupling arrangement 9 into the uncoupled state thereof. For forming the emergency locking device, it can be provided in various embodiments that the switching lever 22 is coupled or can be coupled to an emergency locking lever 24 which is pivotable about an emergency locking lever axis 24a such that an operation, in particular a manual operation, of the emergency locking lever 24 brings about a transfer of the switching lever 22 into the third switching position thereof.

A particularly simple operation of the emergency locking lever 24 can be provided if the emergency locking lever 24 is manually operated by a user, in particular by means of the motor vehicle key, such as with a linear movement of the motor vehicle key, as shown in FIG. 5b) and FIG. 6b) by the motor vehicle key shown in dashed lines.

Starting from FIG. 5a) and FIG. 6a), the emergency locking lever 24 can be pivoted in FIG. 6a) counterclockwise from a basic position into a switching position (FIG. 5b) and FIG. 6b)). The emergency locking lever 24 comes into engagement with the switching lever 22, such that the switching lever 22 is pivoted by the emergency locking lever 24 into the third switching position thereof. This is shown in FIG. 5b) and FIG. 6b).

After the operation of the emergency locking lever 24, in various embodiments this emergency locking lever is automatically transferred back to the basic position thereof, shown in FIG. 5a) and FIG. 6a). To this end, the emergency locking lever 24 is pretensioned into the basic position thereof, in particular spring-pretensioned.

For a simple and effective adjustment of the locking arrangement 20 it can be provided that an opening device 10 is coupled to the locking arrangement 20 such that a raising of the locking pawl 6 in the course of an opening process brings about a transfer of the locking arrangement 20 into the locked state thereof.

Starting from FIG. 3b) and FIG. 4b), in which the locking arrangement 20 is in the unlocked state thereof, the motorized opening process can be started by the opening device 10. The opening drive 11 is operated in the opening direction, whereby the actuating arrangement 12 is adjusted. The actuating arrangement 12 has a worm gear 15 which is adjusted counterclockwise in FIG. 4b). A stop element 25 of the worm gear 15 comes into engagement with an actuating element 26 of the actuating lever 21, such that the actuating lever 21 is pivoted from the second actuating position thereof into the first actuating position thereof, whereby the coupling lever 18 is switched from the engaged position thereof into the disengaged position thereof.

Starting from FIG. 3a) and FIG. 4a), in which the locking arrangement 20 is in the locked state thereof, a motorized opening process can also be started by the opening device 10. As can be seen in FIG. 4a), the stop element 25 of the worm gear 15 is moved past the actuating element 26 of the actuating lever 21, so that the actuating lever 21 remains in the first actuating position thereof and the coupling lever 18 in the disengaged position thereof.

The coupling arrangement 9 is thus always in the disengaged state during normal use of the motor vehicle lock 1. In order to permit the manual opening of the side door from outside in the event of an emergency, it can be provided that the opening device 10 adjusts the actuating arrangement 12, starting from the initial position, in an unlocking movement which runs in the drive direction opposing the opening movement, such that the coupling arrangement 9 switches from the disengaged state into the engaged state via the actuating arrangement 12. In various embodiments, in the event of a crash the opening device 10 switches the coupling arrangement 9 into the engaged state via the actuating arrangement 12.

Starting from FIG. 3a) and FIG. 4a), in which the locking arrangement 20 is in the locked state thereof, the coupling arrangement 9 is in the disengaged state thereof and the actuating arrangement 12 is in the initial position thereof, a motorized unlocking process can be started by the opening device 10. To this end, the opening drive 11 is operated in an unlocking movement opposing the opening movement, whereby the worm gear 15 of the actuating arrangement 12 is adjusted clockwise in FIG. 4a). An unlocking element 27 of the worm gear 15 comes into engagement with an unlocking stop 28 of the actuating lever 21, such that the actuating lever 21 is adjusted from the first actuating position thereof into the second actuating position thereof. By the coupling of the switching lever 22 to the actuating lever 21, this is adjusted from the first switching lever position 22 thereof into the second switching lever position 22 thereof, whereby the coupling lever 18 is switched into the engaged position thereof and thus the coupling arrangement 9 is switched into the engaged state thereof. It is then possible to open the side door from outside via the operating lever 7.

The opening drive 11 is configured to adjust the coupling arrangement 9 sufficiently rapidly in order to permit the manual opening of the side door in a reliable manner in the event of a crash.

In various embodiments and as shown in the figures, the operating lever axis 7a, the opening lever axis 13a and the release lever axis 19a are arranged coaxially to one another, whereby a particularly compact construction of the motor vehicle lock I is provided.

1. A motor vehicle lock with a locking latch which is pivotable about a geometric locking latch axis and with at least one locking pawl which is pivotable about a geometric locking pawl axis, wherein the locking latch is adjustable into an open position and into at least one closed position, in particular into a main closed position and optionally into a preclosed position located between the open position and main closed position, wherein the locking pawl is adjustable into a lowered position in which the locking pawl holds the locking latch in the at least one closed position, and into a raised position in which the locking pawl releases the locking latch, wherein the motor vehicle lock has an operating lever, which is pivotable about a geometric operating lever axis, wherein a coupling arrangement is arranged between the operating lever and the locking pawl, said coupling arrangement being switchable between an engaged state and a disengaged state, wherein in the disengaged state the operating stroke of the operating lever is an idling stroke relative to the raising of the locking pawl, wherein in the engaged state the locking pawl can be transferred via the operating stroke of the operating lever into the released state, wherein the motor vehicle lock has an opening device with a motorized opening drive with at least one drive direction which in an opening movement adjusts an actuating arrangement of the opening device, starting from an initial position of the actuating arrangement, such that the actuating arrangement operates an opening lever of the opening device which is pivotable about an opening lever axis, such that the locking pawl can be transferred by an operating stroke of the opening lever from the lowered position into the raised position, wherein the coupling arrangement is arranged between the opening lever and the locking pawl such that for transferring the locking pawl into the raised position thereof, the opening device is coupled or can be coupled thereto via the coupling arrangement and that the opening device can be uncoupled from the locking pawl via the coupling arrangement.

2. The motor vehicle lock as claimed in claim 1, wherein in the disengaged state of the coupling arrangement the operating stroke of the opening lever brings about the transfer of the locking pawl into the released state thereof, and in the engaged state of the coupling arrangement the operating stroke of the opening lever is an idling stroke relative to the raising of the locking pawl.

3. The motor vehicle lock as claimed in claim 1, wherein in the engaged state and in the disengaged state of the coupling arrangement the operating stroke of the opening lever in each case brings about the transfer of the locking pawl into the released state thereof.

4. The motor vehicle lock as claimed in claim 1, wherein the coupling arrangement is switchable into an uncoupled state in which the operating stroke of the opening lever is an idling stroke.

5. The motor vehicle lock as claimed in claim 1, wherein the coupling arrangement has a coupling lever which is pivotable about a geometric coupling lever axis, the coupling lever in the disengaged state of the coupling arrangement is in a disengaged position in which the coupling lever, with an operating stroke of the operating lever, is out of coupled engagement with the operating lever, and the coupling lever in the engaged state of the coupling arrangement is in an engaged position in which the coupling lever, with an operating stroke of the operating lever, is in coupled engagement with the operating lever or comes into coupled engagement with the operating lever, and the coupling lever in the engaged position and the disengaged position, with an operating stroke of the opening lever, is in coupled engagement with the opening lever or comes into coupled engagement with the opening lever.

6. The motor vehicle lock as claimed in claim 1, wherein in the uncoupled state of the coupling arrangement the coupling lever is in an uncoupled position in which the coupling lever, with an operating stroke of the operating lever, is out of coupled engagement with the operating lever and in which the coupling lever, with an operating stroke of the opening lever, is out of coupled engagement with the opening lever.

7. The motor vehicle lock as claimed in claim 1, wherein the locking pawl is coupled or can be coupled to a release lever which is pivotable about a release lever axis, an operation of the release lever brings about the transfer of the locking pawl into the released state thereof, and the coupling lever is arranged on the release lever so as to be pivotable about a coupling lever axis.

8. The motor vehicle lock as claimed in claim 1, wherein the motor vehicle lock has a locking arrangement which can be brought into a locked state and an unlocked state, an adjustment of the locking arrangement from the locked state thereof into the unlocked state thereof brings about an adjustment of the coupling arrangement from the disengaged state thereof into the engaged state thereof, and an adjustment of the locking arrangement from the unlocked state thereof into the locked state thereof brings about an adjustment of the coupling arrangement from the engaged state thereof into the disengaged state thereof.

9. The motor vehicle lock as claimed in claim 1, wherein the locking arrangement has an actuating lever which is pivotable about a geometric actuating lever axis and a switching lever which is pivotable about a geometric switching lever axis, the pivotable actuating lever can be brought from a first actuating position into a second actuating position, the pivotable switching lever can be brought from a first switching position in which the switching lever holds the coupling lever in the disengaged position thereof, into a second switching position in which the switching lever holds the coupling lever in the engaged position thereof or the coupling lever is in the engaged position thereof, the actuating lever and the switching lever are coupled together such that an adjustment of the actuating lever from the second actuating position into the first actuating position brings about a transfer of the switching lever from the second switching position into the first switching position thereof, and an adjustment of the actuating lever from the first actuating position into the second actuating position brings about a transfer of the switching lever from the first actuating position into the second switching position thereof.

10. The motor vehicle lock as claimed in claim 1, wherein the actuating lever is held by a latching arrangement in the first actuating position thereof and in the second actuating position thereof and the latching arrangement has a latching point which can be latched and which has to be overcome when transferred from the one actuating position to the other actuating position.

11. The motor vehicle lock as claimed in claim 1, wherein the switching lever is pivotable relative to the actuating lever such that, starting from the first switching position, the switching lever can be brought into a third switching position in which the switching lever holds the coupling lever in the uncoupled position thereof without changing the position of the actuating lever.

12. The motor vehicle lock as claimed in claim 1, wherein the motor vehicle lock has an emergency locking device for transferring the coupling arrangement into the uncoupled state thereof.

13. The motor vehicle lock as claimed in claim 1, wherein the opening device is coupled to the locking arrangement such that a raising of the locking pawl in the course of an opening process brings about a transfer of the locking arrangement into the locked state thereof.

14. The motor vehicle lock as claimed in claim 1, wherein the opening drive adjusts the actuating arrangement, starting from the initial position, in an unlocking movement which runs in the drive direction opposing the opening movement, such that the coupling arrangement is transferred via the actuating arrangement from the disengaged state into the engaged state.

15. The motor vehicle lock as claimed in claim 4, wherein the operating stroke of the operating lever is an idling stroke in the uncoupled state of the coupling arrangement.

16. The motor vehicle lock as claimed in claim 7, wherein the coupling lever is pretensioned into the uncoupled position thereof.

17. The motor vehicle lock as claimed in claim 8, the locking arrangement can be brought into an uncoupled state, whereby the coupling arrangement is switched into the uncoupled state thereof.

18. The motor vehicle lock as claimed in claim 12, wherein the switching lever is coupled or can be coupled to an emergency locking lever which is pivotable about an emergency locking lever axis.

19. The motor vehicle lock as claimed in claim 18, wherein a manual operation of the emergency locking lever brings about a transfer of the switching lever into the third switching position thereof.

20. The motor vehicle lock as claimed in claim 14, wherein in the event of a crash the opening device switches the coupling arrangement into the engaged state by means of the actuating arrangement.
